(19) United States
(12) Patent Application Publication
(10) Pub. No.: US 2007/0231090 A1
(43) Pub. Date: Oct. 4, 2007

(54) Hole Saw Alignment Rod and Method of Using Same

(76) Inventor: William Sherry, Old Bridge, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/674,294

(22) Filed: Feb. 13, 2007

Related U.S. Application Data
(60) Provisional application No. 60/773,802, filed on Feb. 15, 2006.

(51) Int. Cl. B23G 11/00

(52) U.S. Cl. 408/69

(57) ABSTRACT

An alignment rod is disclosed which may include a first portion suitable for attachment to a drill and a second portion configured to guide a drilling operation using the drill, wherein the diameter of the alignment rod is at least substantially constant along a length thereof.

### CROSS-REFERENCE TO RELATED APPLICATIONS

This application claims the benefit of U.S. Provisional Patent Application Ser. No. 60/773,802 filed Feb. 15, 2006, the entirety of the disclosure of which application is incorporated herein by reference.

### BACKGROUND OF THE INVENTION

Various construction tasks require the provision of substantial size holes such as for the installation of doorknobs, pipe fittings, or other devices having substantially circular cross sectional geometries. Such holes may be cut using hole saws which are formed with a saw blade wrapped in a circle and used as a drill bit in a conventional powered drill. Because hole saws produce holes of substantial diameter, drilling a hole which is misaligned or mislocated is problematic because such an error may be difficult or impossible to correct. In addition, hole saw operations are subject to chatter and vibration during the drilling process, thereby incurring the consequences of hole misalignment and mislocation which may cause the expenditure of much time and expense to correct. Moreover, vibrations from hole saw operation often results in loosening of the bit from the drill chuck or breakage of the bit. Accordingly, there is a need in the art for improved apparatus and methods for using hole saws.

### SUMMARY OF THE INVENTION

In accordance with one aspect, the invention is directed to an alignment rod that may include a first portion suitable for attachment to a drill and a second portion configured to guide a drilling operation using the drill, wherein the diameter of the alignment rod is at least substantially constant along a length thereof.

In accordance with another aspect, the invention is directed to a method that may include providing a drilling assembly including a hole saw and an alignment rod parallel to and concentric with the hole saw, the alignment rod having an exterior diameter; and engaging an interior diameter of a pilot hole with the exterior diameter of the alignment rod to thereby align the drilling assembly.

According to yet another aspect, the invention is directed to an alignment device for a drill adapted to be operably connected to a hole saw, the alignment device having no cutting surface thereon.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a blown up, partially elevational view and partly sectional view of equipment for drilling a hole and of a workpiece in accordance with one or more embodiments of the present invention;

FIG. 2 is a blown up perspective view of a connection device and an alignment rod in accordance with one or more embodiments of the present invention; and

FIG. 3 is a sectional view of a portion of the alignment rod of FIG. 2, along line A-A′;

FIG. 4 is a side view of an alignment rod in accordance with an alternative embodiment of the present invention;

FIG. 5A is a plan view of a hole saw in accordance with an alternative embodiment of the present invention; and

FIG. 5B is a partly elevational view and partially sectional view of the hole saw of FIG. 5A, along line B-B′.

### DETAILED DESCRIPTION OF THE PREFERRED EMBODIMENTS

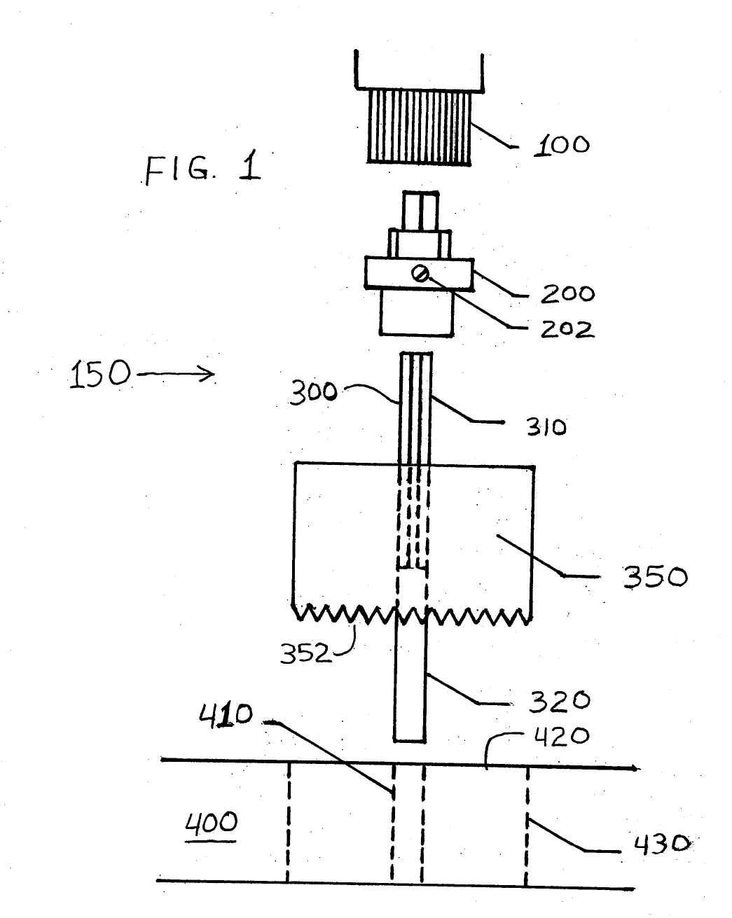

FIG. 1 shows equipment for drilling a hole and a workpiece 400 in accordance with an embodiment of the present invention. More specifically, FIG. 1 shows drill machine 100, drilling assembly 150, and a workpiece (the object to be drilled) 400. Drilling assembly 150 can include connection device 200 (which can be an arbor 200), alignment rod 300, and hole saw 350.

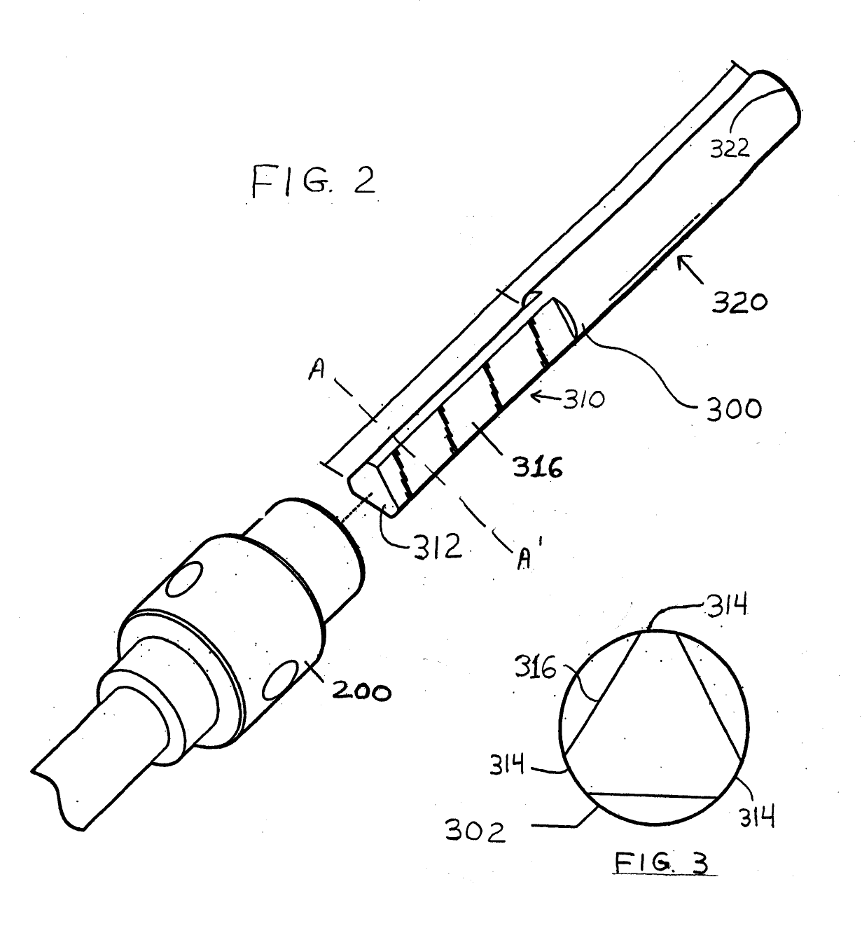

Drill machine 100 may be a powered drill 100 or other torque providing device. Drill machine 100 can include a chuck for holding arbor 200, which could be manually controlled or automatically powered either electrically or otherwise. Arbor 200 can include set screw 202 which may be adjusted to secure the attachment of alignment rod 300 thereto. Hole saw 350 is preferably configured to cut a hole of a given diameter in the workpiece 400. Preferably, a hole saw 350 of any desired diameter may be employed in conjunction with the present invention. While the embodiment of FIG. 1 shows a hole saw 350, other types of drill bits, other cutting instruments, and/or tools for other functions may be employed in addition to, or in place of, hole saw 350. Such other functions could include deburring, grinding, polishing, sanding, among other material treatment and/or modification functions. Tools for performing the above-listed functions may employed in conjunction with the location and alignment systems and methods disclosed herein. The details of alignment rod 300 are discussed in greater detail in connection with FIG. 2.

In the embodiment of FIG. 1, alignment rod 300 is affixed within arbor 200 and secured therein using arbor set screw 202. In turn, the upper end of arbor 200 is inserted into the a chuck (not shown) of drill machine 100 and affixed therein, thereby enabling the transfer of torque from drill machine 100 to alignment rod 300. However, alternatively, alignment rod 300 may be configured to be attached directly to the chuck in drill machine 100. Various other attachment options will be apparent to those of ordinary skill in the art. The present invention is not limited to any particular attachment scheme.

In one embodiment, each of hole saw 350 and alignment rod 300 are directly attached to arbor 200 and are not directly coupled to one another. This arrangement preferably minimizes the transmission of forces and vibration between hole saw 350 and rod 300. Alternatively, hole saw 350 is assembled to alignment rod 300, and this assembly is in turn assemblable to arbor 200, which is in turn assemblable to drill machine 100.

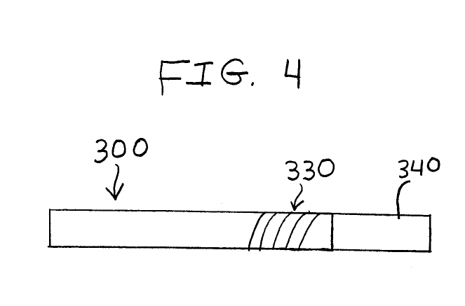

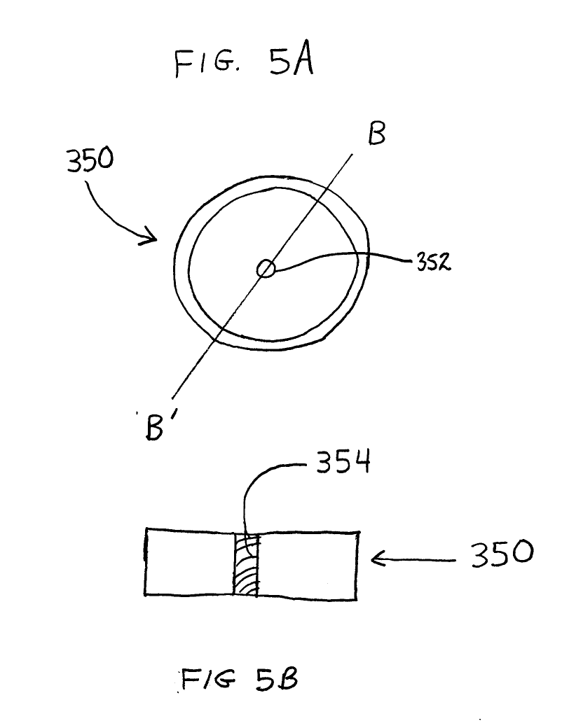

Alignment rod 300 and hole saw 350 may comprise a unitary assembly or separate components that may be joined to each other such as by a screw-type connection as shown in FIGS. 4-5. In this embodiment, rod 300 may include threads 330 adapted to engage threads 354 disposed in a receiving bore provided on hole saw 350. Alternatively, suitable connections means other than a screw-type connection may be employed, as is known to those of ordinary skill in the art. In any case, once any such assembly is complete, the longitudinal axis of alignment rod 300 is preferably located concentrically with respect to the longitudinal axis of hole saw 350.

The workpiece 400 has a top surface 420 and a pilot hole 410. The pilot hole 410 could, in one embodiment, have a diameter of 0.25 inches. However, pilot hole diameters less than or greater than 0.25 inches can be employed. Workpiece 400 could be made of various materials including but not limited to one or more of wood, tin, aluminum, fiberglass, plastics, glass, and ceramic. However, the invention is not limited to drilling the above-listed materials, and any suitable material may be drilled using the inventive principles disclosed herein. Where needed, a hole saw 350 having characteristics specifically suited to the properties of the material being drilled may be deployed for a drilling operation.

Preferably, upon completing a drilling operation employing the apparatus and method discussed herein, an accurately drilled hole 430 is produced, which is preferably located concentrically with pilot hole 410 and preferably accurately matches the outer diameter of hole saw 350. By way of example, the drilled hole 430 could have a diameter of 2 inches. However, the drilled hole could have a diameter less than or greater than 2 inches.

FIG. 2 shows a connection device 200 and an alignment rod 300. FIG. 3 is a sectional view of alignment rod 300 taken from the lower left portion of rod 300 in FIG. 2. Connection device 200 preferably serves as an attachment device to indirectly couple alignment rod 300, among other parts such as hole saw 350, to drill machine 100. In this manner, connection device 200 serves as a link on a “power train” from drill machine 100 to alignment rod 300. Connection device preferably serves the purpose of providing a standard mechanical interface to drill machine 100 while providing an adjustable interface to alignment rod 300 which can accommodate a range of different rod 300 diameters. In FIG. 2, connection device 200 is an arbor. However, connection device 200 could alternatively be a chuck or other suitable part.

Alignment rod 300 may include a first portion 310 suitable for connection to device 200, and may include a second portion 320 suitable for entering pilot hole 410 of workpiece 400 to guide drilling assembly 150 therethrough during a drilling operation. Where alignment rod 300 is coupled directly to arbor 200, alignment rod may be an “arbor blank”. Herein, an arbor blank is an elongated member suitable for performing the alignment function of rod 300 that includes a chuck or arbor-engaging portion and an unfluted, non-cutting portion, which may be smooth and cylindrical.

However, alternatively, alignment rod 200 may be configured to be connected directly to a drill machine 100 such as but not limited to by attachment to a chuck or any other attachment mechanism suitable for transmitting torque originating from drill machine 100 to alignment rod 300.

Alignment rod 300 includes a first portion 310 having a proximal end 312, one or more flats or flat portions 316, and optional rounded portions 314 (FIG. 3) in between the flats 316; and a second portion 320 having a distal end 322. First portion 310 of alignment rod 300 may be configured for attachment to connection device 200, which may be an arbor or chuck. To facilitate the connection of rod 300 to connection device 200, one or more flat surfaces or flats 316 may be provided along the length of the second portion 310 of rod 300. Preferably, at least three flats 316 are provided on first portion 310 of rod 300 that engages connection device 200, it being known to the skilled artisan that conventional drill chucks have at least three engaging members.

Alignment rod 300 may be any suitable length. In one embodiment rod 300 is about 4 inches long, with first portion 310 having a length of about 1.75 inches, and with second portion 320 having a length of about 2.25 inches. However, rod 300 and the first and second portions thereof may be longer or shorter than the respective dimensions listed above. Flats 316 may have any suitable depth as measured from a perimeter 302 of rod 300 to the surface of the flats 316. In one embodiment, flats 316 have a depth of about 0.025 inches with respect to perimeter 302.

Alignment rod 300 preferably has a substantially constant diameter along its length, which diameter may be any suitable diameter. In one embodiment, the diameter is about 0.25 inches. However, the diameter of rod 300 may be greater than or less than 0.25 inches. Moreover, in other embodiments, the diameter of rod 300 may vary along its length. More specifically, a taper or chamfer may be provided at the distal end 322 of rod 300 to aid in initially guiding rod 300 into pilot hole 410.

The perimeter 302 of rod 300 is preferably smooth along its length. A smooth perimeter 302 surface preferably aids in providing stable guidance to drilling assembly 150 during the advancement thereof toward and into workpiece 400. More specifically, in the preferred embodiments, none of flutes (or other cutting surfaces), threads, or shoulders (such as to support additional equipment) are disposed along the perimeter of alignment rod 300. However, one or more of these features may be included in alternative embodiments. The provision of a smooth perimeter 302 surface preferably operates to enable a stable engagement of rod 300 with the interior surface of the pilot hole 410 of workpiece 400. As applied to the first portion 310 of rod 300, the term “diameter” corresponds to twice the radial distance extending from the center of rod 300 first portion 310 to the curved circle segments 314, that are located between flat portions 312, about the exposed surface of first portion 310, as best seen in FIG. 3.

Preferably, the second portion 320 of rod 300 is of circular cross-section throughout its length. However, other geometries could be employed. Preferably, rod 300, particularly second portion 320, is solid throughout its length. That is, rod 300 preferably does not include cavities or openings within its interior volume. A solid construction of rod 300 second portion 320 preferably operates to provide rigidity and stability to the process of guiding rod 300 into pilot hole 410 and of guiding hole saw 350 through workpiece 400.

Attention is now directed to a drilling operation employing the apparatus disclosed herein. Drill machine 100 with drilling assembly 150 attached thereto is preferably brought to an approach position, as shown in blown up form in FIG. 1. Rotation of drilling assembly 150 may then be started. However, the rotation of the drilling assembly 150 could alternatively be postponed until after alignment rod 300 has been inserted some initial distance into pilot hole 410.

Next, alignment rod 300 second portion 320 is inserted into pilot hole 410 to suitably center and align drilling assembly 150 with respect to workpiece 400. If not already rotating, the rotation of drilling assembly may begin as the cutting surface 352 of hole saw 350 approaches surface 420 of workpiece 400.

Drilling assembly 150 is then further advanced toward workpiece 400, thereby advancing hole saw 350 through workpiece 400 to cut hole 430. The advancement of hole saw 350 occurs concurrently with the advancement of alignment rod 300 through pilot hole 410. In this manner, alignment rod 300 operates to provide stability, proper alignment, and proper concentricity (of hole 430 with respect to pilot hole 410) of the drilling operation on an ongoing basis until hole 430 is completely drilled. Since, in the preferred embodiment, perimeter 302 of rod 300 does not include flutes or other cutting surfaces, undesired stresses and forces that may otherwise be present between alignment rod 300 second portion 320 and the interior of pilot hole 410 are beneficially avoided. Upon completion of the drilling of hole 430, drilling apparatus 150 is removed from workpiece 400.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An alignment rod comprising:
a first portion suitable for attachment to a drill and a second portion configured to guide a drilling operation using the drill, wherein the diameter of the alignment rod is at least substantially constant along a length thereof.

2. The alignment rod of claim 1 wherein the first portion is configured for attachment to at least one of: an arbor; and a chuck.

3. The alignment rod of claim 1 wherein the alignment rod is an arbor blank.

4. The alignment rod of claim 1 wherein a perimeter of the alignment rod is substantially smooth along its length.

5. The alignment rod of claim 1 wherein no threads are disposed on a perimeter of the alignment rod.

6. The alignment rod of claim 1 wherein no cutting surfaces are disposed on a perimeter of the alignment rod.

7. The alignment rod of claim 1 further comprising means for attaching a hole saw thereto.

8. A method comprising:
providing a drilling assembly including a drill bit and an alignment rod parallel to and concentric with the drill bit, the alignment rod having an exterior diameter; and
engaging an interior diameter of a pilot hole with the exterior diameter of the alignment rod to thereby align the drilling assembly.

9. The method of claim 8 wherein the pilot hole is located within a workpiece to be drilled with the drilling assembly.

10. The method of claim 8 further comprising:
moving the drilling assembly toward the workpiece with the alignment rod engaged in the pilot hole.

11. The method of claim 8 wherein the engaging step comprises:
contacting the pilot hole with the alignment rod without cutting material surrounding the pilot hole.

12. The method of claim 9 further comprising:
advancing the drill bit through the workpiece, while advancing the alignment rod through the pilot hole, to drill a hole through the workpiece.

13. The method of claim 12 further comprising:
maintaining a proper alignment of the drilling assembly with respect to the workpiece with said advancement of the alignment rod through the pilot hole.

14. The method of claim 12 further comprising:
causing the drilled hole in the workpiece to be concentric with the pilot hole by said advancing of the alignment rod through the pilot hole.

15. An alignment device for a drill adapted to be operably connected to a hole saw, the alignment device having no cutting surface thereon.

16. The alignment device of claim 15 wherein the connection of the alignment device to the hole saw is operable to diminish the transmission of force between a portion of the alignment device for engaging a pilot hole and a cutting surface of the hole saw.
